(19) United States
(12) Patent Application Publication
(10) Pub. No.: US 2026/0244011 A1
(43) Pub. Date: Aug. 20, 2026

(54) Method for controlling optical system in vehicle

(71) Applicant: InnpLux Corporation, Miao-Li County (TW)

(72) Inventors: Yu-Chia HUANG, Miao-Li County (TW); Tsung-Han Tsai, Miao-Li County (TW); Kuan-Feng Lee, Miao-Li County (TW)

(73) Assignee: InnoLux Corporation, Miao-Li County (TW)

(21) Appl. No.: 19/460,368

(22) Filed: Jan. 27, 2026

(30) Foreign Application Priority Data
Feb. 20, 2025 (CN) 202510185363.5

(51) Int. Cl. G02B 27/01; B60K 35/235; B60K 35/81; G02B 27/00

(52) U.S. Cl. CPC G02B 27/0101; B60K 35/235; B60K 35/81; G02B 27/0093; G02B 2027/0118; G02B 2027/013

(57) ABSTRACT

The present disclosure provides a method for controlling an optical system in a vehicle, which includes providing an optical structure with a top region, a middle region and a bottom region, defining a first light condition and a second light condition measured at different times, wherein the top region has a first light transmittance difference ΔT1 between the first light condition and the second light condition, and the middle region has a second light transmittance difference ΔT2 between the first light condition and the second light condition, the bottom region has a third light transmittance difference ΔT3 between the first light condition and the second light condition, wherein the following equation is satisfied: |ΔT1| > |ΔT2| or |ΔT1| > |ΔT3|.

### BACKGROUND OF THE DISCLOSURE

### FIELD OF THE DISCLOSURE

The present disclosure relates to the optical field, particularly to an optical structure capable of adjusting optical changes in different regions based on external light conditions, which can be applied to a vehicle windshield or other products.

### DESCRIPTION OF THE PRIOR ART

With the rapid advancement of technology, display technology has also progressed significantly. From traditional cathode ray tubes (CRT) to liquid crystal displays (LCD), organic light-emitting diodes (OLED), and the like, innovations in display technology have not only improved image quality but also expanded its application scope. Display technology is no longer limited to computer screens or televisions but is applied to various aspects of life, such as smartphones, tablets, wearable devices, and the like.

Among them, the application of display technology in the vehicle field has garnered significant attention. A head-up display (HUD) is a representative example. The HUD system projects driving information, such as vehicle speed, navigation instructions, collision warnings, and the like, onto the windshield in front of the driver, allowing the driver to access critical information without lowering their head, significantly enhancing driving safety and convenience. Furthermore, the development of HUD technology has also driven the application of augmented reality (AR) in vehicles, such as overlaying navigation information as images on real roads, providing drivers with a more intuitive navigation experience.

However, the current in-vehicle display technology still has considerable room for development. For example, the projected images of traditional HUD systems are easily interfered with by sunlight, affecting visibility. With the advancement of autonomous driving technology, the display interfaces inside future vehicles will play a more critical role, needing to provide richer and more personalized information. Therefore, developing new in-vehicle display technologies to meet increasingly complex driving demands has become a key focus of industry research.

### SUMMARY OF THE DISCLOSURE

In one embodiment, the present disclosure provides a method for controlling an optical system in a vehicle, including providing an optical structure having a top region, a middle region, and a bottom region, projecting an image onto the bottom region of the optical structure through an optical projection device, obtaining a first light condition and a second light condition passing through the optical structure in a vehicle through at least one light sensor, wherein the first light condition and the second light condition are measured at different times, wherein the top region has a first light transmittance difference ΔT1 between the first light condition and the second light condition, the middle region has a second light transmittance difference ΔT2 between the first light condition and the second light condition, the bottom region has a third light transmittance difference ΔT3 between the first light condition and the second light condition, wherein the first light transmittance difference ΔT1, the second light transmittance difference ΔT2, and the third light transmittance difference ΔT3 satisfy the following equation: |ΔT1| > |ΔT2| or |ΔT1| > |ΔT3|.

The feature of the present disclosure lies in providing an optical structure applicable to a vehicle windshield, wherein the optical structure can adjust the light transmittance of different regions based on external light conditions. The optical structure of the present disclosure has numerous advantages, such as: 1. It can automatically adjust the light transmittance of the glass based on factors such as ambient light intensity and driver needs, providing a comfortable driving experience. 2. It slows down the rate of temperature increase inside the vehicle, reducing air conditioning usage and lowering energy consumption. 3. Under strong light, it can effectively reduce glare, improving the clarity of the driver’s line of sight. 4. It makes the projection pattern of the optical projection device clearer. 5. In specific scenarios, it can darken the windshield to protect the privacy of occupants inside the vehicle.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 illustrates a cross-sectional schematic diagram of the relationship between a vehicle and a driver.

FIG. 1A illustrates an enlarged schematic diagram of region A in FIG. 1.

FIG. 1B illustrates an enlarged schematic diagram of region B in FIG. 1.

FIG. 2 illustrates a schematic diagram of an optical structure according to a first embodiment of the present disclosure under a first light condition, and a relationship diagram between light transmittance and light intensity in different regions of the optical structure.

FIG. 3 illustrates a schematic diagram of the optical structure according to the first embodiment of the present disclosure under a second light condition, and a relationship diagram between light transmittance and light intensity in different regions of the optical structure.

FIG. 4 illustrates a schematic diagram of an optical structure according to a second embodiment of the present disclosure under a second light condition, and a relationship diagram between light transmittance and light intensity in different regions of the optical structure.

FIG. 5 illustrates a schematic diagram of an optical structure according to a third embodiment of the present disclosure under a first light condition, and a relationship diagram between light transmittance and light intensity in different regions of the optical structure.

FIG. 6 illustrates a schematic diagram of the optical structure according to the third embodiment of the present disclosure under a second light condition, and a relationship diagram between light transmittance and light intensity in different regions of the optical structure.

FIG. 7 illustrates a relationship diagram between light transmittance and light intensity in different regions of an optical structure according to a fourth embodiment of the present disclosure under a second light condition.

FIG. 8 illustrates a cross-sectional schematic diagram of an optical structure according to a fifth embodiment of the present disclosure.

FIG. 9 illustrates a schematic diagram of the sensor distribution of an optical structure according to a sixth embodiment of the present disclosure.

### DETAILED DESCRIPTION

By referring to the detailed description below and simultaneously combining the accompanying drawings, those skilled in the art can understand the content of the present disclosure. It should be noted that, for the sake of simplicity of the drawings and to enable readers to easily understand, each drawing in the present disclosure may only illustrate a portion of the elements, and certain elements in each drawing may not be drawn to actual scale. Furthermore, the number and dimensions of each element shown in the drawings are only illustrative and are not intended to limit the scope of the present disclosure.

Certain terms are used throughout the description and claims of the present disclosure to refer to specific elements. Those skilled in the art should understand that manufacturers of electronic devices may refer to the same element by different names. This document does not intend to distinguish between elements that differ in name but not in function. In the following description and claims, the terms “include,” “comprise,” and “have” are open-ended terms and thus should be interpreted to mean “include, but not limited to…”.

The “electrical connection” described in the present disclosure may include two or more elements being in direct physical contact with each other and conductive with each other; or two or more elements not being in direct contact with each other but being connected through other elements (e.g., wires, contact structures, etc.), all of which conform to the definition of electrical connection described in the present disclosure.

It should be understood that when an element or layer is referred to as being “on” or “connected to” another element or layer, it can be directly on or directly connected to the other element or layer, or intervening elements or layers may be present therebetween. In contrast, when an element is referred to as being “directly on” or “directly connected to” another element or layer, there are no intervening elements or layers present therebetween.

The ordinal terms such as “first,” “second,” etc., used in the description and claims to modify elements do not by themselves imply or represent any previous ordinal number of the claimed elements, nor do they represent the order of one claimed element relative to another claimed element or the sequence in a manufacturing method. The use of such ordinal numbers is merely to clearly distinguish one claimed element having a certain name from another claimed element having the same name.

The electronic device mentioned in the present disclosure may include, for example, a display device, an antenna device, a sensing device, a touch electronic device (touch display), a curved electronic device (curved display), or a non-rectangular electronic device (free shape display), and may also be a bendable or flexible spliced electronic device, but not limited thereto. The electronic device may include, for example, light-emitting diodes, liquid crystal, fluorescence, phosphor, quantum dots (QD), other suitable display media, or a combination thereof, but not limited thereto. The light-emitting diode (LED) may include, for example, an organic light-emitting diode (OLED), an inorganic light-emitting diode (inorganic LED), a sub-millimeter light-emitting diode (mini LED), a micro light-emitting diode (micro LED), or a quantum dot light-emitting diode (QD, e.g., QLED, QDLED), or other suitable materials or any arrangement and combination thereof, but not limited thereto. The antenna device may be, for example, a liquid crystal antenna, but not limited thereto. It should be noted that the electronic device of the present disclosure may be any arrangement and combination of the foregoing, but not limited thereto. Furthermore, the appearance of the electronic device may be rectangular, circular, polygonal, a shape with curved edges, or other suitable shapes. The electronic device may have peripheral systems such as a driving system, a control system, a light source system, a shelf system, etc., to support the display device or the antenna device. In the following paragraphs, the focus will be on describing the features of a vehicle windshield and the method for regulating its light transmittance.

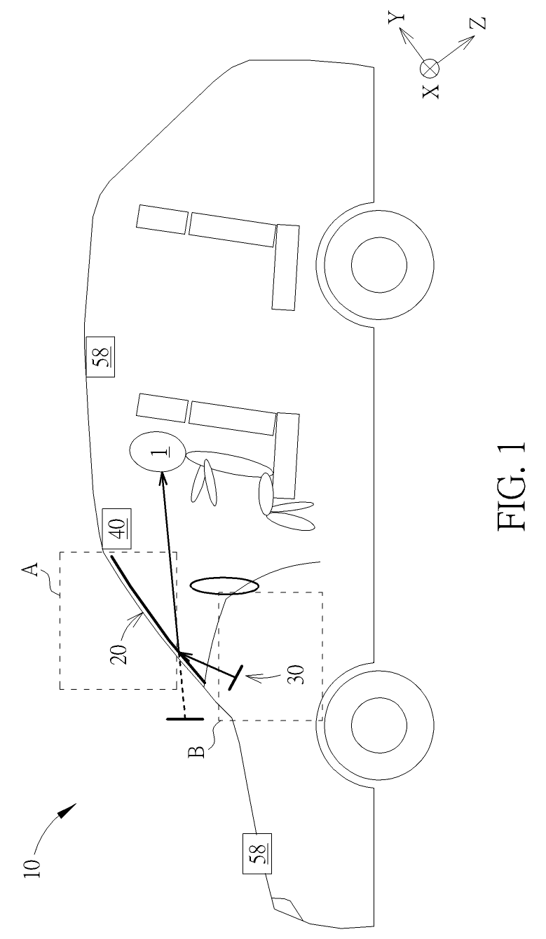

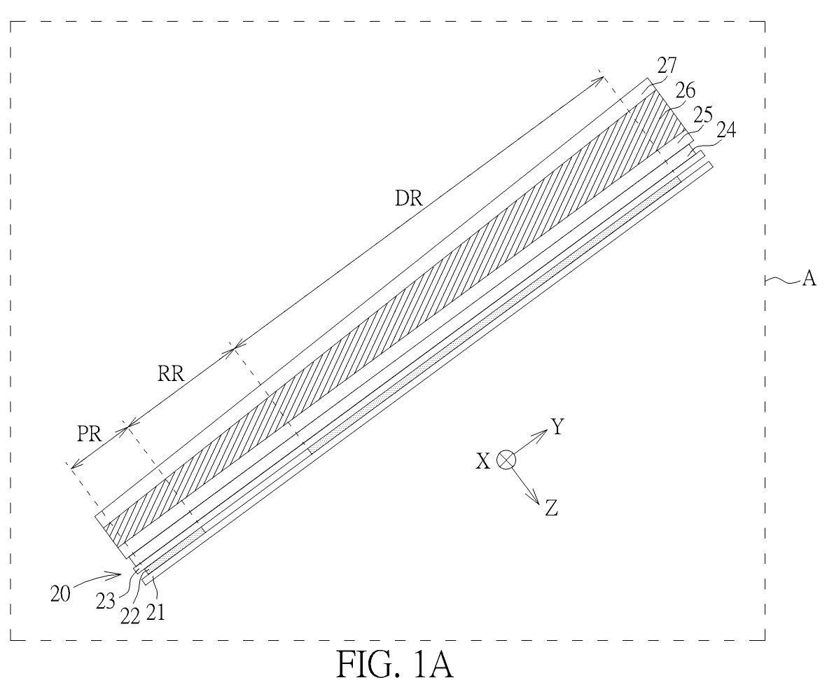

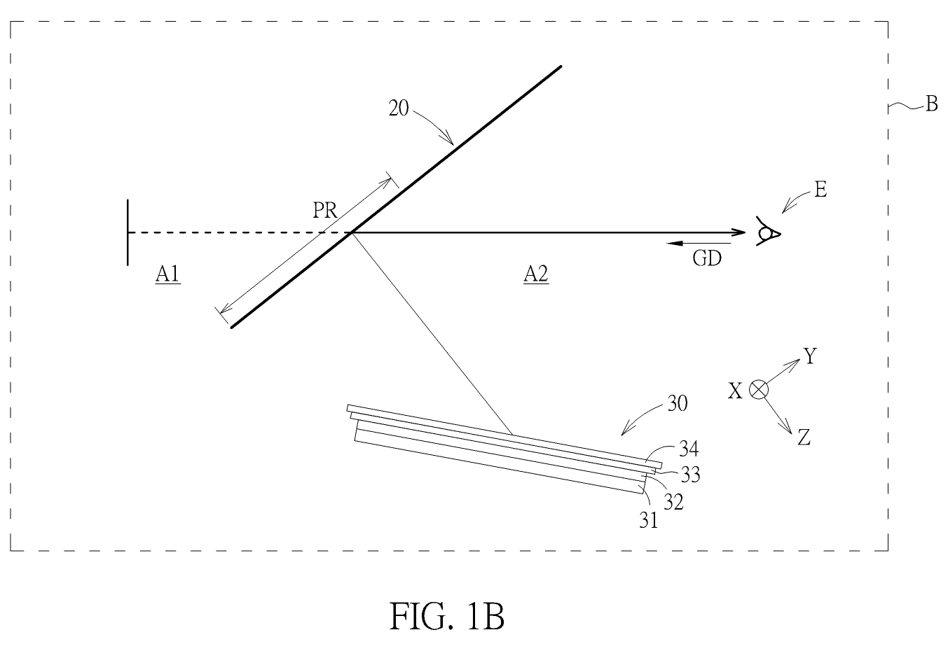

Please refer to FIG. 1, FIG. 1A, and FIG. 1B. FIG. 1 illustrates a cross-sectional schematic diagram of the relationship between a vehicle and a driver, FIG. 1A illustrates an enlarged schematic diagram of region A in FIG. 1, which is also a cross-sectional schematic diagram of an optical structure (e.g., a windshield) according to an embodiment of the present disclosure, and FIG. 1B illustrates an enlarged schematic diagram of region B in FIG. 1, which is also a schematic diagram of the relationship between an optical projection device 30, the optical structure 20 (e.g., a windshield), and the driver’s line of sight. First, as shown in FIG. 1, a driver 1 is seated in a vehicle 10, wherein the vehicle 10 described herein may be a passenger car, a truck, or other types of vehicles, and the present disclosure is not limited thereto. The vehicle 10 of the present disclosure includes several relatively important elements, namely, an optical structure 20 and an optical projection device 30, wherein the optical structure 20 of the present disclosure is, for example, a vehicle windshield, and the optical structure 20 includes a light adjustment material, such as an electrochromic light adjustment material, a photochromic light adjustment material, etc., which can change optical properties under the stimulation of voltage or light, achieving dynamic adjustment of light conditions. When the ambient light is too strong, a local region of the optical structure 20 can automatically darken to reduce glare, enhancing driving comfort. The function of the optical projection device 30 is to project an image onto the optical structure 20, allowing the driver to obtain driving information without lowering their head, thereby improving driving safety. The remaining structure of the vehicle 10 is not a key feature of the present disclosure and will not be further described herein. Additionally, the vehicle 10 may also include an image capturing device 40 and a light sensor 58, the functions of which will be described in more detail in subsequent paragraphs.

The more detailed structure of the optical structure 20 is shown in FIG. 1A. As shown in FIG. 1A, the optical structure 20 of the present disclosure includes a multilayer structure. Taking this embodiment as an example, it includes a cover substrate 21, a light adjustment material layer 22, a cover substrate 23, an adhesive layer 24, a transparent windshield layer 25, an adhesive layer 26, and a transparent windshield layer 27. The aforementioned cover substrate 21, cover substrate 23, adhesive layer 24, transparent windshield layer 25, adhesive layer 26, and transparent windshield layer 27 may be made of transparent materials, such as tempered glass, laminated glass (two pieces of tempered glass sandwiching an adhesive layer), acrylic, plastic, a transparent projection screen, etc., but the present disclosure is not limited thereto. That is to say, although the optical structure 20 in this embodiment is exemplified by a vehicle windshield, in other embodiments of the present disclosure, the optical structure 20 may also be applied to car windows, building windows, building display glass, etc., but the present disclosure is not limited thereto. The light adjustment material layer 22 has the function of changing light transmittance in response to an applied electrical signal, and the materials of the light adjustment material layer 22 will be further introduced in the following paragraphs. The light adjustment material layer 22 is located between the cover substrate 21 and the cover substrate 23, and the function of the cover substrate 21 and the cover substrate 23 is to protect the light adjustment material layer 22. The cover substrate 21 and the cover substrate 23 may include electrodes, which may be transparent electrodes, opaque electrodes, or a combination thereof, capable of supplying voltage to the light adjustment material layer 22 through the electrodes, causing the light transmittance of the light adjustment material layer 22 to change and thereby achieving a shading effect. The adhesive layer 24 is, for example, a transparent adhesive, such as a transparent optical adhesive OCA (Optically Clear Adhesive), liquid optical adhesive OCR (Optical Clear Resin), etc., but not limited thereto, and the adhesive layer 24 is used to connect the cover substrate 23 and the transparent windshield layer 25. The adhesive layer 26 is, for example, polyvinyl butyral (PVB) adhesive, and the adhesive layer 26 is located between the transparent windshield layer 25 and the transparent windshield layer 27, bonding with the transparent windshield layer 25 and the transparent windshield layer 27. The adhesive layer 26 has functions such as enhancing the strength of the glass structure (reducing glass shattering upon breakage) and adjusting refracted light. In this embodiment, from a cross-sectional view, the adhesive layer 26 may have a cross-sectional profile similar to a trapezoid, but the present disclosure is not limited thereto.

Additionally, in addition to the layers described above, the optical structure 20 may optionally include other functional film layers, which may be disposed on the outer surface or inner surface of the optical structure. Examples of the functional film layers include a UV blocking layer, an IR blocking layer, ink, an anti-fouling layer, a waterproof coating, etc., and the materials may include epoxy resin, organosilicon compounds, polyurethane (PU), acrylic acid, nano-coating, resin material, etc., but the present disclosure is not limited thereto.

In this embodiment, the light adjustment material layer 22 includes light transmittance adjustable materials, such as dichroic dye liquid crystal (DDLC), polymer dispersed liquid crystal (PDLC), polymer network liquid crystal (PNLC), cholesteric liquid crystal (CLC), electrochromic (EC) material, suspended particle device (SPD), electronic ink (e ink), photochromic material, etc., but the present disclosure is not limited thereto.

Please continue referring to FIG. 1A. On the optical structure 20 of the present disclosure, different regions are further defined, such as a projection region PR, a restriction region RR, and a dimming region DR defined in FIG. 1A. The projection region PR, the restriction region RR, and the dimming region DR are located at different positions of the optical structure 20 and have different usage functions. When the optical structure 20 adjusts light, different regions will exhibit different optical changes, such as changes in transmittance, transparency, light intensity, haze, or reflectivity. The following embodiments take transmittance as an example, but the present disclosure is not limited thereto. More specifically, the projection region PR is the position where the optical projection device 30 (shown in FIG. 1) projects a pattern. From the perspective of the driver 1, the projection region PR is located near the lower part of the optical structure (e.g., a vehicle windshield) 20. The projection region PR may have a lower light transmittance (darker background color), which allows the pattern projected by the optical projection device 30 to have higher contrast against a dark background, enabling the driver to clearly recognize the pattern projected by the optical projection device 30. The restriction region RR is located in the middle section of the optical structure 20, which is also the primary line-of-sight direction of the driver 1 during driving. To minimize obstruction of the driver 1’s line of sight, when the light transmittance of other regions of the optical structure 20 changes, the restriction region RR may maintain the same light transmittance or exhibit only a small amount of light transmittance change (approximately within 10%, but not limited thereto). As for the dimming region DR, it is located above the driver 1’s field of view and can primarily block strong external light (e.g., sunlight, sunset light, oncoming vehicle headlights, etc.) by adjusting light transmittance. The method of adjusting the light transmittance changes in each region based on ambient light will be described in more detail in the following paragraphs.

In this embodiment, different light adjustment material layers 22 can be provided according to different regions. For example, the light adjustment material layer in the projection region PR can be selected as electrochromic (EC) material, which has a slower response speed but a wider light transmittance adjustment range (adjustable light transmittance range from approximately 5% to 90%), making it suitable for use in the projection region PR as the background for the optical projection device 30. That is to say, the background color can be adjusted to a darker shade to make the projected pattern clearer. As for the light adjustment material layer in the dimming region DR, dichroic dye liquid crystal (DDLC) can be selected, with a light transmittance adjustment range of approximately 10% to 60%, but this material has a faster response speed, making it suitable as the light adjustment material layer 22 in the dimming region DR, allowing rapid response and adjustment of the light transmittance of the dimming region DR based on different ambient light conditions. It is understood that the above examples are merely one embodiment of the present disclosure, and the present disclosure is not limited thereto.

It is worth noting that, although three regions—the projection region PR, the restriction region RR, and the dimming region DR—are defined in FIG. 1A, in practice, more or fewer regions can be defined as needed. For example, there may be transition regions between each region to reduce abrupt changes in light transmittance that could affect the driver’s line of sight. Alternatively, in some embodiments, regions such as the projection region may be omitted. All such variations fall within the scope of the present disclosure.

The more detailed structure of the optical projection device 30 is shown in FIG. 1B. As shown in FIG. 1B, the optical projection device 30 is composed of a multilayer structure, including, for example, a heat dissipation layer 31, a light-emitting unit 32, an adhesive layer 33, and a cover layer 34. The heat dissipation layer 31 is located below the light-emitting unit 32 and dissipates heat generated during the operation of the light-emitting unit 32. The cover layer 34 and the adhesive layer 33 are, for example, transparent layers, and the cover layer 34 is fixed onto the light-emitting unit 32 via the adhesive layer 33. The cover layer 34 serves to protect the underlying components, preventing intrusion of external substances such as dust and moisture, and providing a certain degree of hardness and scratch resistance. The light-emitting unit 32 is used to generate an image signal, converting driving information, for example, into a visible image, which passes sequentially through the adhesive layer 33 and the cover layer 34 before being projected onto the optical structure 20. The light-emitting unit 32 may include, for example, liquid crystal display (LCD), self-emissive display, micro light-emitting diode display (micro LED), organic light-emitting diode display (OLED), waveguide display, etc., but not limited thereto. The remaining related technologies of the optical projection device 30 are known in the art and will not be further described herein.

Furthermore, in addition to using general head-up display (HUD), the present disclosure may also use panoramic head-up display (PHUD) as the optical projection device 30. The differences between PHUD and traditional HUD include, for example: 1. The image light path of PHUD does not undergo mirror reflection (including planar or curved mirrors) before reaching the imaging screen. 2. The image magnification of PHUD is between 1 and 3 times, whereas the magnification of HUD is typically greater than 3 times. 3. The imaging range width of PHUD is greater than 1/2 of the windshield width, whereas that of HUD is typically less than 1/2 of the windshield width. 4. The aspect ratio of the image-generating device (display) of PHUD is typically greater than 3, whereas that of HUD is typically less than 3 (e.g., 4:3, 16:9, or 1:1). It is understood that whether HUD or PHUD is used, both fall within the scope of the present disclosure.

Please continue referring to FIG. 1B. The pattern projected by the optical projection device 30 is irradiated onto the optical structure 20 and enters the driver’s line-of-sight range (the range visible to the eyes E). In addition, light from outside the vehicle also passes through the optical structure 20 and enters the driver 1’s sight. The concept of the present disclosure is to adjust the light transmittance of certain regions of the optical structure 20 based on the strength of ambient light or the gaze direction GD of the driver’s eyes E, reducing excessive light from entering the driver’s line of sight and affecting driving safety. At the same time, the definition of “light transmittance” described herein is explained, and the light transmittance referred to in each paragraph of the present disclosure is interpreted according to this definition. As shown in FIG. 1B, a first surface A1 and a second surface A2 are defined on the two sides of the optical structure 20, respectively, wherein the first surface A1 is, for example, the exterior of the vehicle, and the second surface A2 is, for example, the interior of the vehicle. A reference light source with a known first reference light intensity is provided, allowing the reference light source to penetrate from the first surface A1 of the optical structure 20 to the second surface A2. Then, a light intensity measuring instrument (e.g., CA-310) is provided and placed on the second surface A2 of the optical structure 20 to receive a first transmitted light intensity after the reference light source penetrates the optical structure 20. The percentage obtained by dividing the first transmitted light intensity by the first reference light intensity (first transmitted light intensity/first reference light intensity) is the light transmittance of the optical structure 20. As for the range of measuring light intensity, various area sizes can be used, such as a rectangular range with a side length of 1 μm to 10 cm, depending on the feasible specifications of the actual measuring instrument, and the present disclosure is not limited thereto. In other words, in the present disclosure, the higher the light transmittance, the less the light intensity is attenuated after passing through the optical structure 20; conversely, the lower the light transmittance, the more the light intensity is attenuated after passing through the optical structure 20. To further illustrate, if the light transmittance is 90%, it means that after a light passes through the optical structure 20, the light intensity becomes 90% of the original light intensity; if the light transmittance is 20%, it means that after a light passes through the optical structure 20, the light intensity is only 20% of the original light intensity.

In the subsequent paragraphs, the focus will be on describing the changes in light transmittance of different regions of the optical structure 20 and their relationship with light intensity. It is worth noting that, to more clearly describe the changes in ambient light intensity, a first light condition C1 and a second light condition C2 are defined first below. The so-called ambient light intensity can be measured by the light sensor 58 of the vehicle 10, but the present disclosure is not limited thereto. In this embodiment, the so-called first light condition C1 and second light condition C2 refer to measuring optical changes (e.g., light intensity changes) in the same region in the same manner under different ambient light conditions. More specifically, for example, under conditions where various factors such as measurement position, measurement area size, measurement duration, and statistical method (e.g., taking the average of multiple points) are controlled to be the same, environments with different light intensities are respectively the first light condition C1 and the second light condition C2. In the first light condition C1 and the second light condition C2, due to different ambient light conditions, the light transmittance of each region of the optical structure 20 also changes accordingly. In some embodiments of the present disclosure, when switching between the first light condition C1 and the second light condition C2, the maximum light intensity difference measured in the same region of the optical structure 20 is greater than 500 lux, that is to say, the maximum light intensity of the first light condition C1 is defined as I1, and the maximum light intensity of the second light condition C2 is defined as I2, satisfying the condition |I2-I1| > 500 lux. Several examples are provided for illustration. In scenario 1, the first light condition C1 is nighttime, at which time the light transmittance of each region of the optical structure 20 is a reference value (the light transmittance of each region may differ), while the second light condition C2 is daytime, at which time the light transmittance of each region of the optical structure 20 changes in response to the change in ambient light conditions (the light transmittance of each region may differ). Further examples of other scenarios are provided: In scenario 2, the first light condition is an environment with uniform ambient light (e.g., no oncoming vehicle headlights), while the second light condition is an environment with non-uniform ambient light (e.g., with oncoming vehicle headlights). In scenario 3, the first light condition is an environment where ambient light (e.g., sunset) is not in front of the vehicle, while the second light condition is an environment where ambient light (e.g., sunset) is in front of the vehicle. In scenario 4, the first light condition is an environment with no road reflection (e.g., non-snowy ground), while the second light condition is an environment with road reflection (e.g., snowy ground). It is worth noting that the above scenarios are merely some examples of the present disclosure, and the present disclosure is not limited thereto. Other scenarios requiring adjustment of the light transmittance of the optical structure 20 due to changes in ambient light also fall within the scope of the present disclosure.

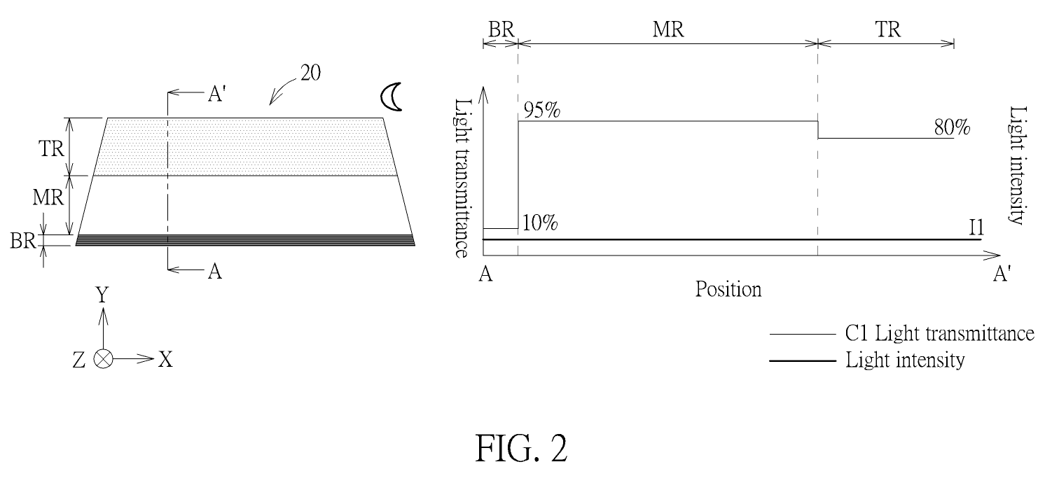

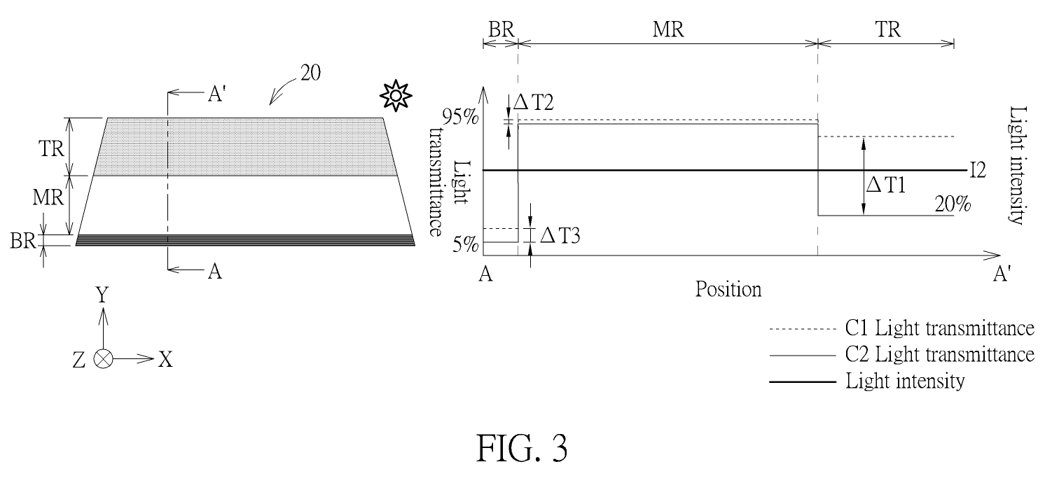

FIG. 2 illustrates a schematic diagram of an optical structure according to a first embodiment of the present disclosure under a first light condition, and a relationship diagram between light transmittance and light intensity in different regions of the optical structure. FIG. 3 illustrates a schematic diagram of the optical structure according to the first embodiment of the present disclosure under a second light condition, and a relationship diagram between light transmittance and light intensity in different regions of the optical structure. As shown in FIG. 2, the optical structure 20 can be divided into several regions. From the driver’s perspective, from top to bottom, these are respectively a top region TR, a middle region MR, and a bottom region BR. Here, the top region TR, the middle region MR, and the bottom region BR correspond to different positions of the optical structure 20, that is to say, the optical structure 20 is divided into the top region TR, the middle region MR, and the bottom region BR according to its different positions. Additionally, it is worth noting that the positions of the dimming region DR, the restriction region RR, and the projection region PR defined earlier according to function may partially or completely overlap with the top region TR, the middle region MR, and the bottom region BR defined here. For example, the bottom region BR may approximately correspond to the range of the projection region PR, or the restriction region RR may be located within the range of the middle region MR, and so forth. However, the definition of each region in the present disclosure can be adjusted as needed, and the present disclosure is not limited thereto.

As shown in FIG. 2, when in the first light condition C1 (e.g., nighttime), a head-up display (not shown) projects driving information, navigation information, etc., onto the optical structure 20. At this time, since the bottom region BR is primarily used as the background for the projection pattern of the head-up display, it maintains a relatively low light transmittance (e.g., approximately 10%, but not limited thereto) to make the projected pattern more clearly visible. The middle region MR serves as the primary line-of-sight range for driving, so the middle region MR has a high light transmittance (e.g., approximately 95%, but not limited thereto). As for the top region TR, it maintains a relatively high light transmittance (e.g., approximately 80%, but not limited thereto) to block some ambient light, such as streetlights or moonlight. In the table on the right half of FIG. 2, the horizontal axis represents different positions (regions along the section line A-A’), the left vertical axis represents light transmittance (in percentage %), and the right vertical axis represents ambient light intensity (in lux). As shown in FIG. 2, the maximum light intensity I1 is a certain value, indicating that the ambient light is uniform at this time, with no locally strong light generated.

As shown in FIG. 3, when in the second light condition C2 (e.g., daytime), the ambient light is stronger at this time, so the light transmittance of each region of the optical structure 20 is adjusted accordingly, such as reducing the light transmittance of each region to minimize the impact of excessive ambient light on the driver’s field of view. It is worth noting that in this embodiment, when the ambient light condition changes (from the first light condition C1 to the second light condition C2), the degree of decrease in light transmittance varies across the regions. Please refer to FIG. 3. In the chart on the right half of FIG. 3, a thin dashed line represents the light transmittance of each region in the first light condition C1 (same as shown in FIG. 2), and a solid line represents the light transmittance of each region in the second light condition C2. Thus, the difference between the two represents the magnitude of change in light transmittance. It can be seen from FIG. 3 that in this embodiment, the top region TR exhibits the largest change in light transmittance, decreasing from approximately 80% to approximately 20%, and this change in light transmittance of the top region TR is defined as ΔT1. The middle region MR exhibits the smallest change in light transmittance, decreasing from approximately 95% to approximately 93%, and this change in light transmittance of the middle region MR is defined as ΔT2. The bottom region BR has a change in magnitude between the two, with its light transmittance decreasing from approximately 10% to approximately 5%, and this change in light transmittance of the bottom region BR is defined as ΔT3. The aforementioned changes in light transmittance of each region are one example of the present disclosure, and in other embodiments of the present disclosure, the conditions 100% > |ΔT1| ≥ 50%, 5% ≥ |ΔT2| ≥ 0, 50% > |ΔT3| > 5%, and ΔT1 > ΔT3 > ΔT2 are satisfied, but the present disclosure is not limited thereto. It is worth noting that ΔT2 can be 0, meaning that when the ambient light changes, the light transmittance of the middle region MR can remain unchanged to reduce the impact on the driver’s line of sight.

Furthermore, the method for calculating the magnitude of change in light transmittance of each region here can be, under two different light conditions (the first light condition C1 and the second light condition C2), taking a single point to calculate the light intensity and light transmittance change value, or taking multiple points to calculate the light intensity and light transmittance change value using methods such as averaging, taking the maximum value, or integrating. All of the above fall within the scope of the present disclosure, and the present disclosure is not limited thereto.

It is worth noting that the optical projection device 30 can project text, numbers, or various images onto the optical structure 20, wherein the text, numbers, or images can be used to represent various driving information. For example, weather information (e.g., a sun pattern representing sunny weather), time (e.g., represented by numbers), or images representing other vehicle information, entertainment information, driving information, warning information, etc., can be projected within the range of the bottom region BR. However, the present disclosure is not limited to projecting only within the bottom region BR; it can also project into other regions. For example, navigation information, current driving speed, road alignment assistance lines, and other patterns can be projected into the middle region MR or other regions, and such variations also fall within the scope of the present disclosure.

From the comparison of FIG. 2 and FIG. 3 above, it can be seen that when the ambient light changes (e.g., from nighttime to daytime), the light transmittance of each region of the optical structure 20 also changes accordingly, and the magnitude of change in light transmittance differs across different regions. Taking the application of the optical structure 20 to a vehicle windshield as an example, when the light condition changes, it can block excess ambient light to reduce the driver’s perception of glare while maintaining the light transmittance of the primary line-of-sight range, thereby improving driving comfort without affecting driving safety.

The following will describe different embodiments, and for simplicity, the descriptions below will primarily detail the differences between each embodiment, without repeating the same aspects. Furthermore, identical elements in each embodiment are denoted by the same reference numerals to facilitate comparison between the embodiments.

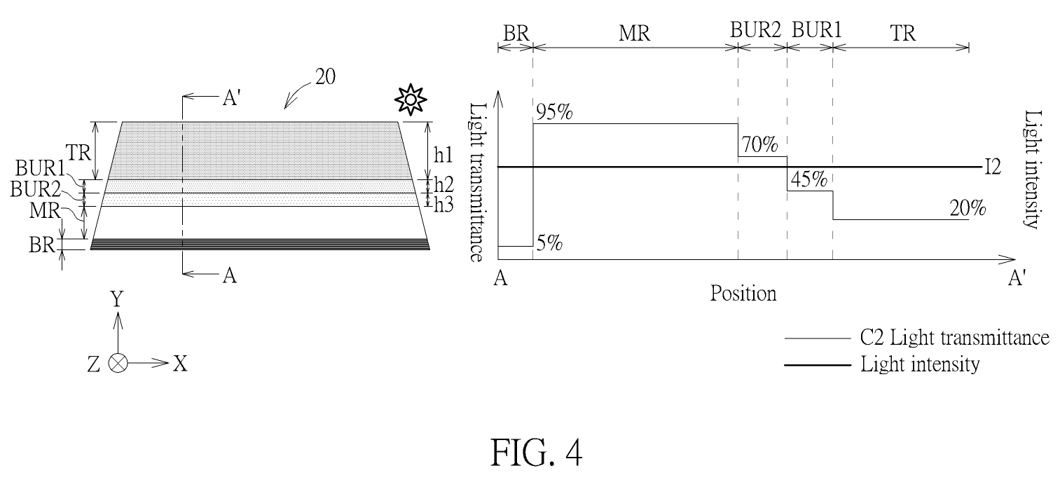

FIG. 4 illustrates a schematic diagram of an optical structure according to a second embodiment of the present disclosure under a second light condition, and a relationship diagram between light transmittance and light intensity in different regions of the optical structure. As shown in FIG. 4, the situation of the optical structure 20 of this embodiment in the first light condition is similar to that shown in FIG. 2 above and will not be repeated here. When the ambient light condition changes, to reduce the excessive difference in the magnitude of light transmittance change at the boundaries between different regions that could affect the viewing field, in this embodiment, some buffer regions are added between the top region TR and the middle region MR, such as a buffer region BUR1 and a buffer region BUR2. The buffer region BUR1 is adjacent to the top region TR and located between the top region TR and the buffer region BUR2, while the buffer region BUR2 is adjacent to the middle region MR and located between the middle region MR and the buffer region BUR1. In this embodiment, the light transmittance of the buffer region BUR1 and the buffer region BUR2 is between that of the two adjacent regions. For example, the light transmittance of the buffer region BUR1 is greater than the light transmittance of the top region TR but less than the light transmittance of the buffer region BUR2, and the light transmittance of the buffer region BUR2 is greater than the light transmittance of the buffer region BUR1 but less than the light transmittance of the middle region MR. Taking this embodiment as an example, the light transmittance of the buffer region BUR1 is approximately 45%, and the light transmittance of the buffer region BUR2 is approximately 70%, but the present disclosure is not limited thereto. As seen in FIG. 4, the lengths (or heights) of the top region TR, the buffer region BUR1, the buffer region BUR2, and the middle region MR in the Y direction are denoted as h1, h2, and h3, respectively. It is understood that the lengths h1-h3 can be adjusted according to actual needs and are not limited by the present disclosure. Additionally, in other embodiments of the present disclosure, more buffer regions can be added, all of which fall within the scope of the present disclosure.

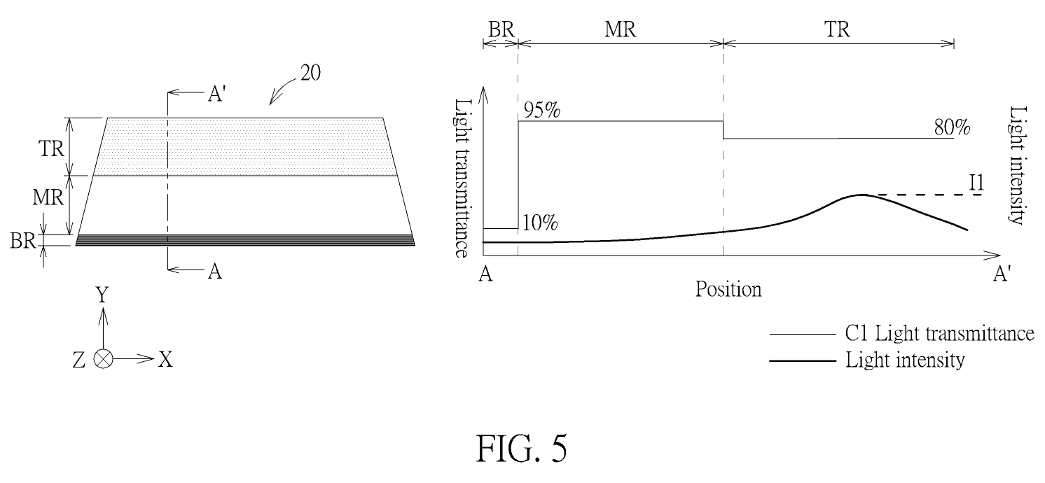

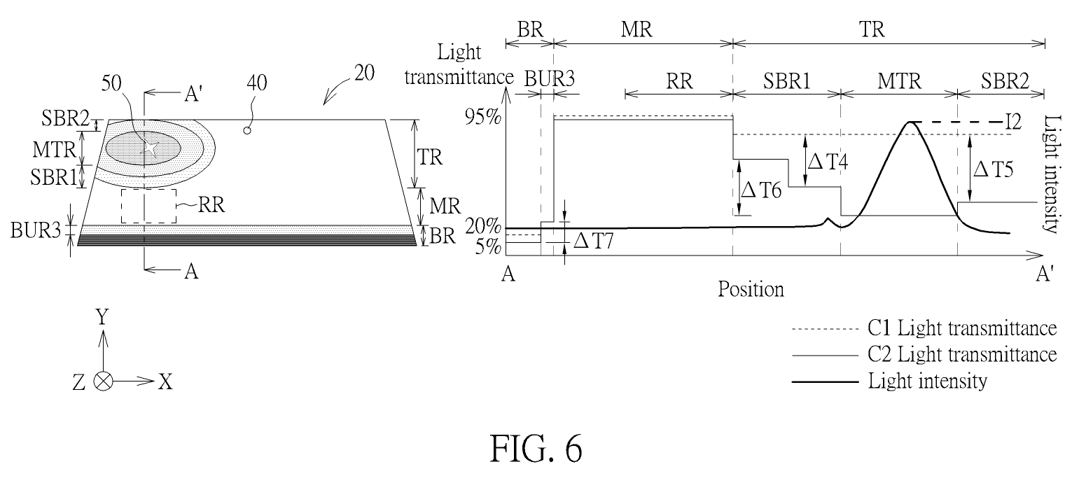

FIG. 5 illustrates a schematic diagram of an optical structure according to a third embodiment of the present disclosure under a first light condition, and a relationship diagram between light transmittance and light intensity in different regions of the optical structure. FIG. 6 illustrates a schematic diagram of the optical structure according to the third embodiment of the present disclosure under a second light condition, and a relationship diagram between light transmittance and light intensity in different regions of the optical structure. The difference between this embodiment and the first embodiment described above lies in that, in the first embodiment shown in FIGS. 2-3, the ambient light source is a uniform light source (e.g., uniform illumination at night and day), so the light intensity received by each region is roughly the same, or, based on considerations of manufacturing cost and data computation power, a single light intensity value is adopted as the first light condition or the second light condition. Therefore, in the charts, the line corresponding to light intensity is a horizontal line. However, in this embodiment, the ambient light source may be a non-uniform light source. For example, the first light condition C1 may be a nighttime scenario with streetlights on the road. Since ambient light enters the vehicle from above, the light intensity passing through the top region TR is slightly higher than that of other regions (as seen in FIG. 5, the line representing light intensity is not a horizontal line, and the maximum light intensity I1 at this time is the maximum value of the curve). The second light condition C2 of this embodiment is also nighttime, but with localized strong glare (e.g., from headlights of an oncoming vehicle) passing through the optical structure 20 into the vehicle. At this time, the corresponding region of the optical structure 20 adjusts its light transmittance based on the position of the glare to reduce the driver’s discomfort. As shown in FIG. 6, if the position of the glare 50 is within a certain region (e.g., the top region TR), it is not necessary to adjust the light transmittance of the entire region. Instead, the position where the glare appears is taken as a center point, and the light transmittance is adjusted sequentially outward from the center point. Taking this embodiment as an example, the position where the glare 50 appears is defined as the center point, and the light transmittance at the center point is adjusted to a lower value, while the area around the center point is set as a buffer region, with the light transmittance gradually increasing outward from the center point in the buffer region to reduce excessive changes in light transmittance between different regions. Additionally, when the glare 50 occurs, it means that the light intensity detected in a certain region of the optical structure 20 increases. The manufacturer can preset the optical structure 20, for example, setting it to reduce the light transmittance of a region when the light intensity passing through that region of the optical structure 20 exceeds a threshold, thereby achieving the purpose of adjusting the light transmittance at the position where the glare 50 appears, as shown in FIG. 6.

Furthermore, the image capturing device 40 included in the vehicle in FIG. 1 is used to record the driving situation inside the vehicle or to observe the gaze direction GD of the driver. In this embodiment, the image capturing device 40 can be connected to the optical structure 20 and transmit signals to each other. The image capturing device 40 determines the position of the restriction region RR on the optical structure 20 based on the gaze direction GD of the driver. More specifically, FIG. 6 defines a restriction region RR, wherein the light transmittance of the restriction region RR does not change with light conditions (or the light transmittance changes only slightly). That is to say, if a certain region on the optical structure 20 is defined as the restriction region RR, whether switching from the first light condition C1 to the second light condition C2 or from the second light condition C2 back to the first light condition C1, the light transmittance within the restriction region RR does not change. Typically, the restriction region RR is the driver’s line-of-sight direction during driving, so maintaining a constant light transmittance in the restriction region RR can reduce obstruction of the driver’s line of sight during driving. It is worth noting that in some embodiments, when the restriction region RR overlaps with the position where the glare 50 occurs, the restriction region RR takes priority. That is to say, if the glare 50 occurs within the restriction region RR, the light transmittance of the restriction region RR is not changed, reducing sudden changes in the driver’s line-of-sight range that could affect driving safety. In some embodiments of the present disclosure, a light sensor 60 may overlap the optical structure 20, and the light sensor 60 can be used to sense the light intensity passing through the optical structure 20. However, in other embodiments of the present disclosure, one or more light sensors 60 may also be disposed within the optical structure 20 or beside the optical structure 20. The present disclosure does not limit the number or position of the light sensors 60, and all such variations fall within the scope of the present disclosure.

In the present disclosure, the positions of regions such as the restriction region RR, the buffer region BUR1, the buffer region BUR2, the dimming region DR, etc., can be determined by detecting the driver’s gaze direction. For example, the direction and intensity of ambient light are first detected, then the viewing direction of the driver’s eyes is detected using the image capturing device 40 connected to the optical structure 20 described above, and then the position on the optical structure (windshield) 20 through which the ambient light passes to the human eye is determined, and the positions of the restriction region RR, the buffer region BUR1, the buffer region BUR2, the dimming region DR, and other regions are determined, followed by corresponding light transmittance adjustments.

Although in this embodiment the image capturing device 40 is disposed inside the vehicle, in other embodiments of the present disclosure, one or more image capturing devices 40 may also be disposed within the optical structure 20 or beside the image capturing device 40. The present disclosure does not limit the number or position of the image capturing devices 40, and all such variations fall within the scope of the present disclosure.

Additionally, in FIG. 6, there is a buffer region BUR3 located between the bottom region BR and the middle region MR, a first sub-buffer region SBR1 located between the top region TR and the middle region MR, and a first sub-buffer region SBR2 located above the top region TR. The functions of the buffer region BUR3, the first sub-buffer region SBR1, and the first sub-buffer region SBR2 described here are the same as those of the buffer regions described above. Setting the light transmittance of the buffer regions to a value between the light transmittance of the two adjacent regions can reduce excessive differences in light transmittance between different regions. It is understood that the number and positions of buffer regions in the present disclosure can be increased or decreased as needed.

In this embodiment, when switching between the first light condition C1 and the second light condition C2, the light transmittance change value within the first sub-buffer region SBR1 is defined as ΔT4, and the light transmittance change value within the second sub-buffer region SBR2 is defined as ΔT5, wherein in some embodiments of the present disclosure, the condition |ΔT4| < |ΔT5| is satisfied. As shown in FIG. 6, since the position of the first sub-buffer region SBR1 is between the top region TR and the middle region MR, its light transmittance change magnitude should be between the light transmittance change magnitudes of the top region TR and the middle region MR, while the second sub-buffer region SBR2 is farther from the middle region MR, so there is no need to consider the light transmittance change of the middle region MR. Therefore, in the second light condition, the light transmittance of the second sub-buffer region SBR2 can be closer to the light transmittance of the top region TR, that is to say, the light transmittance change magnitude |ΔT5| of the second sub-buffer region SBR2 may be greater than the light transmittance change magnitude |ΔT4| of the first sub-buffer region SBR1, but the present disclosure is not limited thereto.

Furthermore, in this embodiment, the first sub-buffer region SBR1 and the second sub-buffer region SBR2 are located within the range of the top region TR, and the buffer region BUR3 is located within the range of the bottom region BR. Additionally, a main region MTR is defined within the top region TR, wherein the main region MTR is located between the first sub-buffer region SBR1 and the second sub-buffer region SBR2.

As shown in FIG. 6, when in the second light condition C2, the maximum light transmittance difference within the top region TR is defined as ΔT6, and the maximum light transmittance difference within the bottom region BR is defined as ΔT7. In some embodiments of the present disclosure, the condition |ΔT6| > |ΔT7| is satisfied. That is to say, in the second light condition, the maximum light transmittance difference |ΔT6| within the top region TR will be greater than the maximum light transmittance difference |ΔT7| within the bottom region BR. However, the present disclosure is not limited thereto.

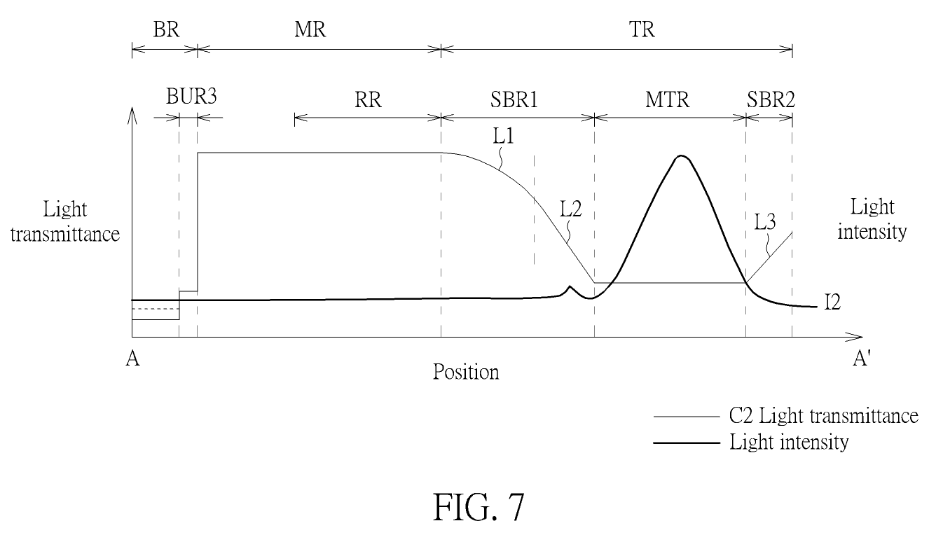

FIG. 7 illustrates a relationship diagram between light transmittance and light intensity in different regions of an optical structure according to a fourth embodiment of the present disclosure under a second light condition. In the embodiments described above, the light transmittance within the same buffer region is a fixed value. For example, in FIG. 4, the light transmittance of the top region TR is approximately 25%, the light transmittance of the buffer region BUR1 is approximately 40%, the light transmittance of the buffer region BUR2 is approximately 70%, and the light transmittance of the middle region MR is approximately 95%, wherein the light transmittance of each region is a fixed value. Therefore, in the charts, the line representing light transmittance within the same region is a horizontal line, and the light transmittance change between the buffer region and adjacent regions appears as a step-like change. However, in other embodiments of the present disclosure, the light transmittance change within the buffer region can exhibit a linear change (a straight slope) or a non-linear change (e.g., a curve). As shown in FIG. 7, within the first sub-buffer region SBR1, there is a section exhibiting a curve (e.g., curve L1 in FIG. 7) and another section exhibiting a straight slope (e.g., straight slope L2 in FIG. 7), while within the second sub-buffer region SBR2, it exhibits a straight slope L3. That is to say, the light transmittance within the buffer region (sub-buffer region) can exhibit a continuous gradient change, and such variations also fall within the scope of the present disclosure.

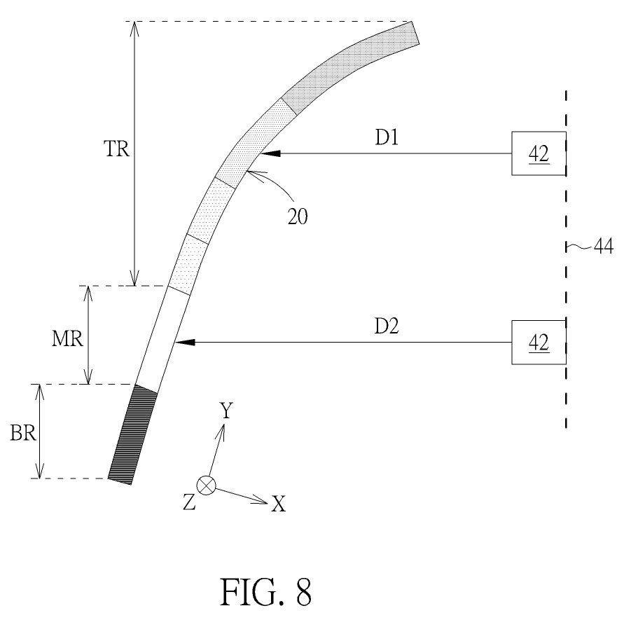

FIG. 8 illustrates a cross-sectional schematic diagram of an optical structure according to a fifth embodiment of the present disclosure. As shown in FIG. 8, each region of the optical structure 20 can have different curvatures, and regions with different curvatures have different light transmittances. A higher curvature indicates that the structure of that region is more curved, while a lower curvature indicates that the region is relatively flat. In some embodiments, the bottom region BR (or the projection region PR) can have a lower curvature, that is, a relatively flat region in the cross-sectional view, which can prevent distortion of the image projected by the head-up display. The top region can have a higher curvature, that is, a relatively curved position in the cross-sectional view, to shield ambient light from a wider angle. It is worth mentioning that the method of defining “curvature” here is as follows: One method is to use a rangefinder 42 to measure the distance from various positions on the surface of the optical structure to the same reference plane 44, where the spacing between the positions may be the same or different. For example, in FIG. 8, at different positions on the reference plane 44, the distances from the rangefinder 42 to the optical structure 20 are D1 and D2, respectively, where the distance D1 is different from the distance D2. Alternatively, lines in the same direction with spacings all within 10 cm are used to obtain the curvature of each segment of the optical structure surface in a certain direction, wherein the curvature of each segment is determined by at least three measurement points. Another method is to use a curvature gauge with a known curvature and observe the most similar curvature in a matching manner to obtain a surface curvature.

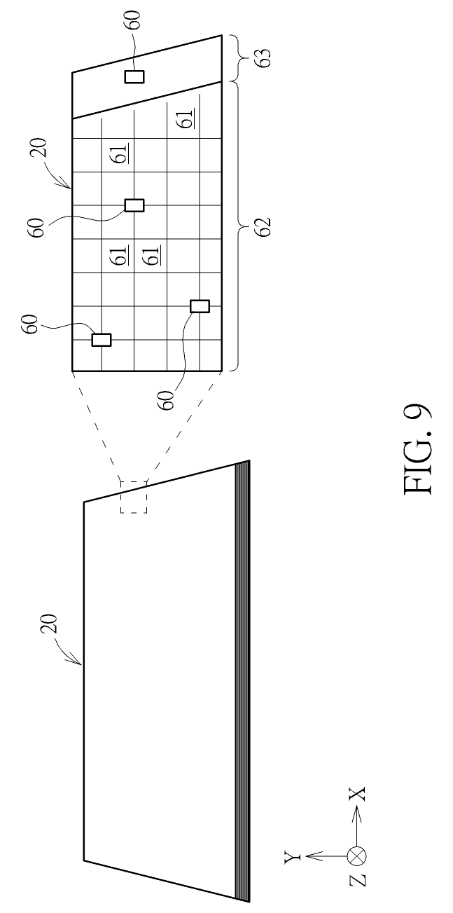

FIG. 9 illustrates a schematic diagram of the sensor distribution of an optical structure according to a sixth embodiment of the present disclosure. To more accurately determine the light intensity passing through the optical structure 20, a plurality of light sensors 60 can be distributed on the optical structure 20 of the present disclosure. The light sensors 60 can detect the light intensity passing through that region, and combined with the aforementioned camera, the steps of defining each region (e.g., the restriction region RR, the dimming region DR, etc.) as described in the present disclosure and adjusting the light transmittance of different regions can be achieved. As shown in FIG. 9, the optical structure 20 may include a main region 62, wherein a plurality of dimming pixels 61 are arranged in an array within the main region 62, and each dimming pixel 61 can independently change its light transmittance based on a signal. A peripheral region 63 surrounds the main region 62, and the peripheral region 63 can serve as an area to protect the boundaries of the optical structure 20. It is worth noting that one or more light sensors 60 can be distributed within the main region 62 and the peripheral region 63, and their distribution number and positions are not limited by the present disclosure. It is worth noting that the light sensor 58 disposed within the vehicle 10 described above can be used to measure ambient light intensity, while the light sensors 60 disposed on the optical structure 20 can be used to sense the light intensity passing through the optical structure 20. In the present disclosure, the number and positions of the light sensors 58 and the light sensors 60 are not limited.

Based on the above description and drawings, the present disclosure provides a method for controlling an optical system in a vehicle, including providing an optical structure 20 having a top region TR, a middle region MR, and a bottom region BR, projecting an image onto the bottom region BR of the optical structure 20 through an optical projection device 30, and obtaining a first light condition (e.g., FIG. 2, FIG. 5) and a second light condition (e.g., FIG. 3, FIG. 4, FIG. 6) passing through the optical structure 20 in a vehicle 10 through at least one light sensor 58, wherein the first light condition C1 and the second light condition C2 are measured at different times, wherein the top region TR has a first light transmittance difference ΔT1 between the first light condition C1 and the second light condition C2, the middle region MR has a second light transmittance difference ΔT2 between the first light condition C1 and the second light condition C2, the bottom region BR has a third light transmittance difference ΔT3 between the first light condition C1 and the second light condition C2, wherein the first light transmittance difference ΔT1, the second light transmittance difference ΔT2, and the third light transmittance difference ΔT3 satisfy the following equation: |ΔT1| > |ΔT2| or |ΔT1| > |ΔT3|.

In some embodiments of the present disclosure, the image capturing device 40 may include an eye-tracking sensor to obtain a gaze direction GD of a user’s eyes in the vehicle, and based on the gaze direction GD of the user’s eyes (e.g., eye position or pupil direction), determine an adjustable light transmittance position on the optical structure 20.

In some embodiments of the present disclosure, the first light condition C1 and the second light condition C2 differ in a maximum light intensity, a light intensity average value, or a light intensity total sum.

In some embodiments of the present disclosure, the first light condition has a first maximum light intensity I1, the second light condition has a second maximum light intensity I2, and the first maximum light intensity I1 and the second maximum light intensity I2 satisfy the following equation: |I2-I1| > 500 lux.

In some embodiments of the present disclosure, in the first light condition, a light transmittance of the middle region MR is greater than a light transmittance of the bottom region BR.

In some embodiments of the present disclosure, the first light transmittance difference ΔT1 and the third light transmittance difference ΔT3 satisfy the following equation: 0% < ||ΔT1|-|ΔT3|| < 90%.

In some embodiments of the present disclosure, the first light transmittance difference ΔT1 and the third light transmittance difference ΔT3 satisfy the following equation: 10% < ||ΔT1|-|ΔT3|| < 50%.

In some embodiments of the present disclosure, the top region TR has a main region MTR, a first sub-buffer region SBR1, and a second sub-buffer region SBR2, the main region MTR is disposed between the first sub-buffer region SBR1 and the second sub-buffer region SBR2, in the first light condition C1, the main region MTR has a first light transmittance Tm, the first sub-buffer region SBR1 has a second light transmittance Ts1, the second sub-buffer region SBR2 has a third light transmittance Ts2, wherein the first light transmittance Tm, the second light transmittance Ts1, and the third light transmittance Ts2 satisfy the following equation: Tm < Ts1, and Tm < Ts2.

In some embodiments of the present disclosure, the first sub-buffer region SBR1 has a fourth light transmittance difference ΔT4 between the first light condition C1 and the second light condition C2, the second sub-buffer region SBR2 has a fifth light transmittance difference ΔT5 between the first light condition C1 and the second light condition C2, and the fourth light transmittance difference ΔT4 and the fifth light transmittance difference ΔT5 satisfy the following equation: |ΔT4| < |ΔT5|.

In some embodiments of the present disclosure, the first sub-buffer region SBR1 is closer to the middle region MR than the second sub-buffer region SBR2.

In some embodiments of the present disclosure, the second light transmittance difference ΔT2 of the middle region MR between the first light condition C1 and the second light condition C2 satisfies the following equation: 5% ≥ |ΔT2| ≥ 0.

In some embodiments of the present disclosure, in the second light condition C2, the top region TR has a sixth light transmittance difference ΔT6, the bottom region BR has a seventh light transmittance difference ΔT7, and the sixth light transmittance difference ΔT6 and the seventh light transmittance difference ΔT7 satisfy the following equation: |ΔT6| > |ΔT7|.

In some embodiments of the present disclosure, in the first light condition C1, the top region TR has a plurality of first light transmittances, and the distribution of the plurality of first light transmittances is in a stepped form (e.g., the embodiments of FIG. 4 or FIG. 6).

In some embodiments of the present disclosure, in the first light condition C1, the top region has a plurality of first light transmittances, and the distribution of the plurality of first light transmittances is in a linear form (e.g., the embodiment of FIG. 7).

In some embodiments of the present disclosure, a surface of the top region TR has a first curvature, a surface of the bottom region BR has a second curvature, and the first curvature is greater than the second curvature (as shown in FIG. 8).

In some embodiments of the present disclosure, the optical projection device 30 has a light-emitting unit 32 and a cover layer 34 overlapping the light-emitting unit, and the image emitted by the light-emitting unit 32 passes through the cover layer 34.

The feature of the present disclosure lies in providing an optical structure applicable to a vehicle windshield, wherein the optical structure can adjust the light transmittance of different regions based on external light conditions. The optical structure of the present disclosure has numerous advantages, such as: 1. It can automatically adjust the light transmittance of the glass based on factors such as ambient light intensity and driver needs, providing a comfortable driving experience. 2. It slows down the rate of temperature increase inside the vehicle, reducing air conditioning usage and lowering energy consumption. 3. Under strong light, it can effectively reduce glare, improving the clarity of the driver’s line of sight. 4. It makes the projection pattern of the optical projection device clearer. 5. In specific scenarios, it can darken the windshield to protect the privacy of occupants inside the vehicle.

The above description is merely embodiments of the present disclosure, and any equivalent changes and modifications made in accordance with the scope of the patent application of the present disclosure shall fall within the scope of the present disclosure.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for controlling an optical system in a vehicle, comprising:
providing an optical structure having a top region, a middle region, and a bottom region;
projecting an image onto the bottom region of the optical structure through an optical projection device; and
obtaining a first light condition and a second light condition corresponding to ambient light passing through the optical structure in the vehicle through at least one light sensor, wherein the first light condition and the second light condition are measured at different times;
wherein the top region has a first light transmittance difference ΔT1 between the first light condition and the second light condition, the middle region has a second light transmittance difference ΔT2 between the first light condition and the second light condition, the bottom region has a third light transmittance difference ΔT3 between the first light condition and the second light condition;
wherein the first light transmittance difference ΔT1, the second light transmittance difference ΔT2, and the third light transmittance difference ΔT3 satisfy the following equation: |ΔT1| > |ΔT2| or |ΔT1| > |ΔT3|.

2. The method according to claim 1, further comprising:
obtaining a gaze direction of a user’s eyes in the vehicle through an eye-tracking sensor; and
determining an adjustable light transmittance position on the optical structure based on the gaze direction of the user’s eyes.

3. The method according to claim 1, wherein the first light condition and the second light condition differ in a maximum light intensity, a light intensity average value, or a light intensity total sum.

4. The method according to claim 3, wherein the first light condition has a first maximum light intensity I1, the second light condition has a second maximum light intensity I2, and the first maximum light intensity I1 and the second maximum light intensity I2 satisfy the following equation: |I2-I1| > 500 lux.

5. The method according to claim 1, wherein in the first light condition, a light transmittance of the middle region is greater than a light transmittance of the bottom region.

6. The method according to claim 1, wherein the first light transmittance difference ΔT1 and the third light transmittance difference ΔT3 satisfy the following equation: 0% < ||ΔT1|-|ΔT3|| < 90%.

7. The method according to claim 6, wherein the first light transmittance difference ΔT1 and the third light transmittance difference ΔT3 satisfy the following equation: 10% < ||ΔT1|-|ΔT3|| < 50%.

8. The method according to claim 1, wherein the top region has a main region, a first sub-buffer region, and a second sub-buffer region, the main region is disposed between the first sub-buffer region and the second sub-buffer region, in the first light condition, the main region has a first light transmittance Tm, the first sub-buffer region has a second light transmittance Ts1, the second sub-buffer region has a third light transmittance Ts2, wherein the first light transmittance Tm, the second light transmittance Ts1, and the third light transmittance Ts2 satisfy the following equation: Tm < Ts1, and Tm < Ts2.

9. The method according to claim 8, wherein the first sub-buffer region has a fourth light transmittance difference ΔT4 between the first light condition and the second light condition, the second sub-buffer region has a fifth light transmittance difference ΔT5 between the first light condition and the second light condition, and the fourth light transmittance difference ΔT4 and the fifth light transmittance difference ΔT5 satisfy the following equation: |ΔT4| < |ΔT5|.

10. The method according to claim 9, wherein the first sub-buffer region is closer to the middle region than the second sub-buffer region.

11. The method according to claim 1, wherein the second light transmittance difference ΔT2 of the middle region between the first light condition and the second light condition satisfies the following equation: 5% ≥ |ΔT2| ≥ 0.

12. The method according to claim 1, wherein in the second light condition, the top region has a sixth light transmittance difference ΔT6, the bottom region has a seventh light transmittance difference ΔT7, and the sixth light transmittance difference ΔT6 and the seventh light transmittance difference ΔT7 satisfy the following equation: |ΔT6| > |ΔT7|.

13. The method according to claim 1, wherein in the first light condition, the top region has a plurality of first light transmittances, and the distribution of the plurality of first light transmittances is in a stepped form.

14. The method according to claim 1, wherein in the first light condition, the top region has a plurality of first light transmittances, and the distribution of the plurality of first light transmittances is in a linear form.

15. The method according to claim 1, wherein a surface of the top region has a first curvature, a surface of the bottom region has a second curvature, and the first curvature is greater than the second curvature.

16. The method according to claim 1, wherein the optical projection device has a light-emitting unit and a cover layer overlapping the light-emitting unit, and the image emitted by the light-emitting unit passes through the cover layer.
